(19) United States
(12) Patent Application Publication
(10) Pub. No.: US 2020/0089720 A1
(43) Pub. Date: Mar. 19, 2020

(54) DELIVERY OF CONTEXTUAL CONTENT USING BLOCKCHAIN DATA

(71) Applicant: Keith Dallara, Mountain Lakes, NJ (US)

(72) Inventor: Keith Dallara, Mountain Lakes, NJ (US)

(21) Appl. No.: 16/568,359

(22) Filed: Sep. 12, 2019

Related U.S. Application Data
(60) Provisional application No. 62/731,301, filed on Sep. 14, 2018.

(51) Int. Cl. G06F 16/9535; G06F 16/9538; H04L 9/06; G06Q 20/12; G06Q 20/06

(52) U.S. Cl. CPC G06F 16/9535; G06F 16/9538; G06Q 20/0658; G06Q 20/123; H04L 9/0637

(57) ABSTRACT

Various embodiments correspond to providing content to a user wherein the content is accessed from a content data store separate from a website and provided as if it were part of the website. The content is selected based on contextual information corresponding to the user's activity on a distributed ledger as determined based on user information accessed from a user information data store generated by mining user information from the distributed ledger where activity from distributed application(s) (dApps) or token transfers occurred. The user information may be accessed by using a ledger address that corresponds to the user and is associated with the distributed ledger.

### CROSS-REFERENCE TO RELATED APPLICATIONS

This application claims priority to U.S. Application No. 62/731,301, filed Sep. 14, 2018, the content of which is hereby incorporated by reference in its entirety.

### BACKGROUND

As users interact with the online world, information regarding the user is generated and may be stored.

### BRIEF SUMMARY OF SOME EXAMPLE EMBODIMENTS

Various embodiments provide methods, apparatus, systems, computer program products, and/or the like for identifying and providing contextual content to a user. In an example embodiment, the contextual content is generated based on user information/data available via a distributed ledger. A blockchain is an example of a distributed ledger. Some example blockchains include Ethereum, EOS, Tezos, Cardano, and Iota. For example, user information/data may be extracted from a public distributed ledger, in various embodiments. In various embodiments, the user information/data may be generated and/or provided to the distributed ledger via a decentralized application (dApp). In an example embodiment, the contextual content may be provided to the user via a dApp. Some examples of dApps include IDEX (decentralized cryptocurrency exchange), Crypt® Kitties (collectible, tradeable, unique digital assets), and PeepEth (decentralized version of Twitter).

In an example embodiment, a user visiting a website or the like may be identified and a distributed ledger account corresponding to the user may be identified. For example, the distributed ledger account may be associated with a ledger address. In various embodiments, the ledger address is the location where modifications to the state of the distributed ledger are attributed. These state modifications may include movement of tokens into or out of the ledger address, the addition of data to a smart contract (e.g., a smart contract of a dApp's) data store, and/or the other transactions and/or events. For example, to add a sell order to IDEX, a state change is recorded by the IDEX smart contract indicating that the ledger address pledges to sell a token for a specific price. The distributed ledger may then be searched and/or queried using the ledger address to identify user information/data corresponding to the user that may be used to identify, determine, generate, and/or the like contextual content for the user. As an example of available user information/data that can be collected, for users who use a distributed exchange like IDEX, the quantities and varieties of currencies that are traded can be determined. For users who use PeepEth, all the tweets posted by a user can be extracted. For users who trade CryptoKitties, the value of a user's collectables and the frequency of activity can be determined. Each of these types of data can be used to generate and/or select targeted contextual content. The targeted contextual content may then be provided to the user, for example, via the website.

According to a first aspect, an apparatus, such as a provider computing entity, is provided. In an example embodiment, the apparatus comprises at least one processor; at least one memory storing computer program code and a user information data store; and a communication interface configured for communicating via at least one network. The at least one memory and the computer program code are configured to, with the processor, cause the apparatus to at least receive a ledger address, the ledger address corresponding to a user of a distributed ledger-based distributed application, access user information corresponding to the ledger address from the user information data store, analyze the user information to determine contextual information, and provide the contextual information such that an exchange computing entity receives the contextual information. The exchange computing entity uses the contextual information to determine one or more characteristics of an instance of content. A content computing entity accesses an instance of content from a content data store and provides the instance of content such that a user computing entity receives the content and provides the content as part of a web site.

According to another aspect, a method for providing contextual content to a user operating a user computing entity. In an example embodiment, the method comprises receiving, by a provider computing entity, a ledger address, the ledger address corresponding to a user of a distributed ledger-based distributed application; accessing, by the provider computing entity, user information corresponding to the ledger address from a user information data store stored in a computer-readable memory of the provider computing entity; analyzing, by the provider computing entity, the user information to determine contextual information; and providing, by the provider computing entity, the contextual information such that an exchange computing entity receives the contextual information. The exchange computing entity uses the contextual information to determine one or more characteristics of an instance of content. A content computing entity accesses an instance of content from a content data store and provides the instance of content such that a user computing entity receives the content and provides the content as part of a web site.

According to still another aspect, a computer program product is provided. In an example embodiment, the computer program product comprising at least one non-transitory computer-readable storage medium having computer-executable program code instructions stored therein. The computer-executable program code instructions comprise program code instructions configured to receive a ledger address, the ledger address corresponding to a user of a distributed ledger-based distributed application; access user information corresponding to the ledger address from a user information data store; analyze the user information to determine contextual information; and provide the contextual information such that an exchange computing entity receives the contextual information. The exchange computing entity uses the contextual information to determine one or more characteristics of an instance of content. A content computing entity accesses an instance of content from a content data store and provides the instance of content such that a user computing entity receives the content and provides the content as part of a web site.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A is a diagram of a system that can be used to practice various embodiments of the present invention.

FIG. 1B is a diagram of another system that can be used to practice various embodiments of the present invention.

FIG. 2 is a schematic of a computing entity in accordance with certain embodiments of the present invention.

FIG. 3 is a schematic of another computing entity in accordance with certain embodiments of the present invention.

FIG. 4 is a flowchart illustrating various procedures, processes, operations, and/or the like that may be performed to provide a user with contextual content, in accordance with certain embodiments.

FIG. 5 is a flowchart illustrating various procedures, processes, operations, and/or the like for generating and maintaining a user information/data data store, in accordance with certain embodiments.

FIG. 6 provides a data flow diagram illustrating various processes, procedures, operations, and/or the like for providing content to a user, in accordance with certain embodiments.

### DETAILED DESCRIPTION OF EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

Embodiments of the present invention may leverage distributed ledger technology to identify, determine, generate and/or provide contextual information/data corresponding a user. In various embodiments, the contextual information/data may be used to select, identify, generate, and/or determine contextual content to provide to the user. An example embodiment uses user information/data generated via user interaction with a dApp by to generate, identify, and/or determine the contextual content corresponding to the user. The contextual content may then be provided to the user.

For example, a user may interact with a dApp (e.g., via a user computing entity). The user interaction with the dApp may cause, initiate, and/or the like one or more transactions and/or events that are recorded in entries of a distributed ledger corresponding to the dApp. In an example embodiment, one or more distributed ledgers may be accessed to generate, update, and/or maintain a user information/data data store. In various embodiments, when a trigger is identified (e.g., a user accesses, via the user computing entity, a website, Internet-accessible portal, and/or application including contextual content serving code) user information/data corresponding to the user may be accessed (e.g., via querying the distributed ledger and/or the user information/data data store). The user information/data may then be used to generate, identify, select, and/or the like contextual content to be provided to the user. The contextual content may then be provided to the user (e.g., via the user computing entity) via the website, Internet-accessible portal, application, and/or the like.

In an example embodiment, the distributed ledger is a blockchain. A blockchain is a collection of records organized as “blocks”. These blocks are linked together sequentially with each new “block” added to the end of the “chain”. Each record contains updates about the state of the blockchain such that a new block is only added once it has been approved by a majority or plurality of the members of the blockchain according to an agreed upon voting and/or consensus algorithm. Typically, blockchains are maintained by a peer-to-peer network of nodes or by a centralized authority. Bitcoin and Ethereum are early examples of peer-to-peer, decentralized blockchains.

### I. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of a data structure, apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

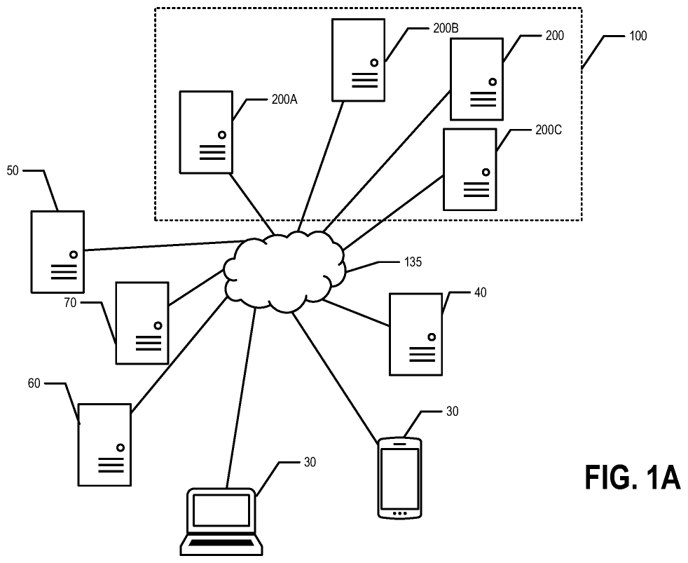

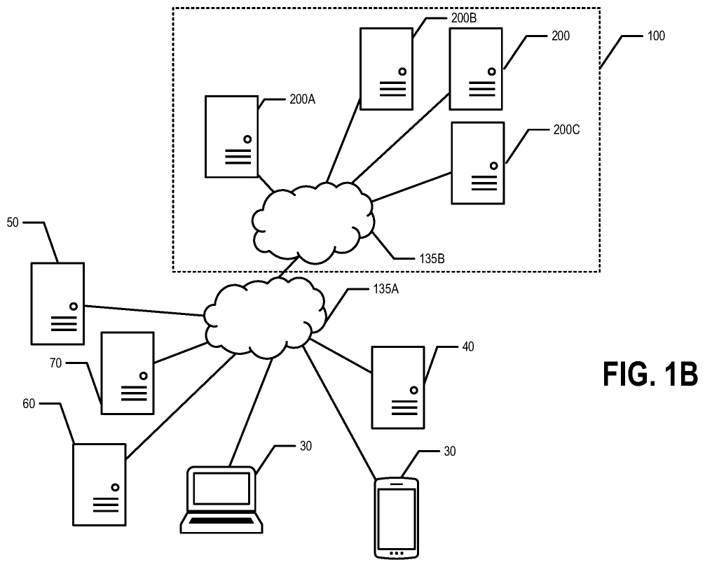

FIG. 1A provides an illustration of a system that can be used in conjunction with various embodiments of the present invention. As shown in FIG. 1A, the system may comprise a distributed ledger system 100 comprising a plurality of node computing entities 200. In various embodiments, the node computing entities 200 are nodes of the distributed ledger of the distributed ledger system 100. As shown in FIG. 1A, the system may further comprise one or more user computing entities 30, one or more provider computing entities 40, one or more networks 135, and/or the like. FIG. 1B provides an illustration of another system that can be used in conjunction with various embodiments of the present invention. As shown in FIG. 1B, the system may comprise a distributed ledger system 100 comprising a plurality of node computing entities 200, 200′ and one or more internal and/or private networks 135B. For example, in an example embodiment, the distributed ledger system 100 comprises a two or more node computing entities 200, 200′ in communication with one another via an internal and/or private network 135B. For instance, the internal and/or private network 135B may be an internal or private network. As shown in FIG. 1B, the system may further comprise one or more user computing entities 30, one or more provider computing entities 40, one or more other and/or external networks 135A, and/or the like. For example, the other and/or external network 135A may be external, public, and/or a different network from the internal and/or private network 135B. For instance, the external network 135A may be the Internet. Each of the components of the system may be in electronic communication with, for example, one another over the same or different wireless or wired networks 135, 135A, 135B including, for instance, a wired or wireless Personal Area Network (PAN), Local Area Network (LAN), Metropolitan Area Network (MAN), Wide Area Network (WAN), or the like. Additionally, while FIGS. 1A and/or 1B illustrate certain system entities as separate, standalone entities, the various embodiments are not limited to this particular architecture.

a. Exemplary Node Computing Entity

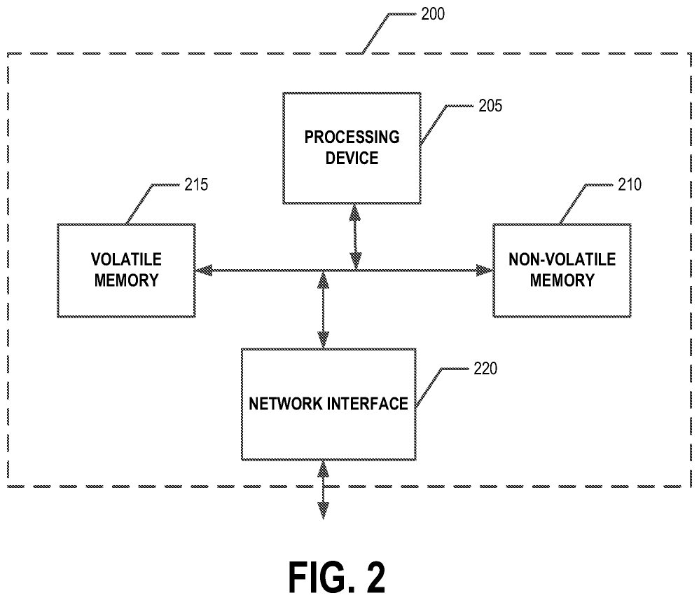

FIG. 2 provides a schematic of a node computing entity 200 according to one embodiment of the present invention. In general, the terms node computing entity, computing entity, entity, device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, relays, routers, network access points, base stations, the like, and/or any combination of devices or entities adapted to perform the functions, operations, and/or processes described herein. Such functions, operations, and/or processes may include, for instance, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

In various embodiments, a node computing entity 200 is operated by and/or on behalf of an entity, individual, organization, department of a corporation, and/or the like that is a member of the distributed ledger system 100. In an example embodiment, some or all of the node computing entities 200 are nodes of the distributed ledger of the distributed ledger system 100. For example, a node of a distributed ledger may store a copy of the distributed ledger, participate in consensus and/or voting functions for the distributed ledger, supply instances of transaction/event information/data for recording in the distributed ledger, access instances of transaction/event information/data from the distributed ledger, and/or the like.

As indicated, in one embodiment, the node computing entity 200 may also include one or more network and/or communications interfaces 220 for communicating with various computing entities, such as by communicating data, content, information, and/or similar terms used herein interchangeably that can be transmitted, received, operated on, processed, displayed, stored, and/or the like. For instance, the node computing entity 200 may communicate with other node computing entities 200, 200′, one or more user computing entities 30, and/or the like.

As shown in FIG. 2, in one embodiment, the node computing entity 200 may include or be in communication with one or more processing elements 205 (also referred to as processors, processing circuitry, and/or similar terms used herein interchangeably) that communicate with other elements within the node computing entity 200 via a bus, for instance. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the node computing entity 200 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably may refer to a structured collection of records or information/data that is stored in a computer-readable storage medium, such as via a relational database, hierarchical database, and/or network database.

In one embodiment, the node computing entity 200 may further include or be in communication with volatile media (also referred to as volatile storage, memory, memory storage, memory circuitry and/or similar terms used herein interchangeably). In one embodiment, the volatile storage or memory may also include one or more volatile storage or memory media 315 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management system entities, data, applications, programs, program modules, scripts, source code, object code, byte code, compiled code, interpreted code, machine code, executable instructions, and/or the like being executed by, for instance, the processing element 305. Thus, the databases, database instances, database management system entities, data, applications, programs, program modules, scripts, source code, object code, byte code, compiled code, interpreted code, machine code, executable instructions, and/or the like may be used to control certain aspects of the operation of the node computing entity 200 with the assistance of the processing element 205 and operating system.

As indicated, in one embodiment, the node computing entity 200 may also include one or more network and/or communications interfaces 220 for communicating with various computing entities, such as by communicating data, content, information, and/or similar terms used herein interchangeably that can be transmitted, received, operated on, processed, displayed, stored, and/or the like. For instance, the node computing entity 200 may communicate with computing entities or communication interfaces of other node computing entities 200, 200′, and/or the like.

As indicated, in one embodiment, the node computing entity 200 may also include one or more network and/or communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the node computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

As will be appreciated, one or more of the node computing entity's 200 components may be located remotely from other node computing entity 200 components, such as in a distributed system. Furthermore, one or more of the components may be combined and additional components performing functions described herein may be included in the node computing entity 200. Thus, the node computing entity 200 can be adapted to accommodate a variety of needs and circumstances.

In example embodiments, the node computing entity 200 may be in communication with one or more other node computing entities 200, 200′, one or more provider computing entities 40, and/or one or more user computing entities 30. In example embodiments, the node computing entity 200 may be in communication with one or more other node computing entities 200, 200′ configured for submitting instances of information/data; validating instances of information/data; accessing and/or providing access to instances of information/data; managing time dependent values of data assets within the distributed ledger (e.g., instances of information/data), tokens, and/or data access costs; performing consensus processing; storing a copy of a distributed ledger; and/or the like. In an example embodiment, the distributed ledger is a blockchain.

b. Another Exemplary Node Computing Entity

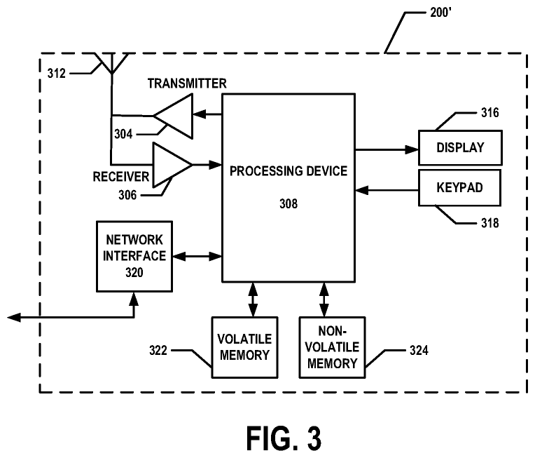

FIG. 3 provides an illustrative schematic representative of another node computing entity 200′ that can be used in conjunction with embodiments of the present invention. As shown in FIG. 3, a node computing entity 200′ can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as another node computing entity 200, 200′, one or more user computing entities 30, and/or the like. In this regard, the node computing entity 200′ may be capable of operating with one or more air interface standards, communication protocols, modulation types, and access types. More particularly, the node computing entity 200′ may operate in accordance with any of a number of wireless communication standards and protocols. In a particular embodiment, the node computing device 200′ may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the node computing entity 200′ can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The node computing entity 200′ can also download changes, add-ons, and updates, for instance, to its firmware, software (e.g., including executable instructions, applications, program modules), and operating system.

According to one embodiment, the node computing entity 200′ may include location determining aspects, devices, modules, functionalities, and/or similar words used herein interchangeably. For example, the node computing entity 200′ may include outdoor positioning aspects, such as a location module adapted to acquire, for instance, latitude, longitude, altitude, geocode, course, direction, heading, speed, UTC, date, and/or various other information/data. In one embodiment, the location module can acquire data, sometimes known as ephemeris data, by identifying the number of satellites in view and the relative positions of those satellites. The satellites may be a variety of different satellites, including LEO satellite systems, DOD satellite systems, the European Union Galileo positioning systems, the Chinese Compass navigation systems, Indian Regional Navigational satellite systems, and/or the like. Alternatively, the location information/data may be determined by triangulating the computing entity's 200′ position in connection with a variety of other systems, including cellular towers, Wi-Fi access points, and/or the like. Similarly, the node computing entity 200′ may include indoor positioning aspects, such as a location module adapted to acquire, for example, latitude, longitude, altitude, geocode, course, direction, heading, speed, time, date, and/or various other information/data. Some of the indoor aspects may use various position or location technologies including RFID tags, indoor beacons or transmitters, Wi-Fi access points, cellular towers, nearby computing devices (e.g., smartphones, laptops) and/or the like. For instance, such technologies may include iBeacons, Gimbal proximity beacons, BLE transmitters, Near Field Communication (NFC) transmitters, and/or the like. These indoor positioning aspects can be used in a variety of settings to determine the location of someone or something to within inches or centimeters.

The node computing entity 200′ may also comprise a user interface device comprising one or more user input/output interfaces (e.g., a display 316 and/or speaker/speaker driver coupled to a processing element 308 and a touch screen, keyboard, mouse, and/or microphone coupled to a processing element 308). For instance, the user output interface may be configured to provide an application, browser, user interface, interface, dashboard, screen, webpage, page, and/or similar words used herein interchangeably executing on and/or accessible via the node computing entity 200′ to cause display or audible presentation of information/data and for user interaction therewith via one or more user input interfaces. The user input interface can comprise any of a number of devices allowing the node computing entity 200′ to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the node computing entity 200′ and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the node computing entity 200′ can collect information/data, user interaction/input, and/or the like.

The node computing entity 200′ can also include volatile storage or memory 322 and/or non-volatile storage or memory 324, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the node computing entity 200′.

In example embodiments, the node computing entity 200′ may be in communication with one or more other node computing entities 200, 200′, one or more provider computing entities 40, and/or one or more user computing entities 30. In example embodiments, the node computing entity 200′ may be in communication with one or more other node computing entities 200, 200′ configured for submitting instances of information/data; validating instances of information/data; accessing and/or providing access to instances of information/data; performing consensus processing; storing a copy of a distributed ledger; and/or the like. In an example embodiment, the distributed ledger is a blockchain.

c. Exemplary User Computing Entity

In an example embodiment, a user computing entity 30 may be a computing entity configured for user interaction (e.g., via one or more user interface devices thereof) for interaction with one or more dApps, providing of contextual content, and/or the like. In various embodiments, a user may be a person interacting with a user computing entity 30 (e.g., via the user interface devices thereof). In various embodiments, the user computing entity 30 may be a computing entity external to the distributed ledger (e.g., the user computing entity 30 is not a node of the distributed ledger). In an example embodiment, a user computing entity 30 may be a node computing entity 200, 200′.

In an example embodiment, a user computing entity 30 may be in communication with one or more node computing entities 200, 200′ and/or one or more provider computing entities 40 via one or more wired or wireless networks 135. In one embodiment, the user computing entity 30 may include one or more components that are functionally similar to those of a node computing entity 200, 200′. For example, in one embodiment, a user computing entity 30 may include: (1) a processing element that communicates with other elements via a system interface or bus; (2) a user interface comprising one or more user interface devices (e.g., display, touchscreen display, hard or soft keyboard, mouse, and/or other user input and/or output devices); (3) transitory and non-transitory memory; and (4) a network and/or communications interface configured to communicate via one or more wired or wireless networks 135. For instance, the user computing entity 30 may receive user input (e.g., via the user input interface thereof) and provide (e.g., transmit) an indication of the user input to one or more node computing entities 200, 200′ (e.g., via the network and/or communications interface). In another example, the user computing entity 30 may receive asset information/data provided by one or more node computing entities 200, 200′ and provide at least a portion of the received asset information/data via an IUI provided via the user interface.

d. Exemplary Provider Computing Entity

In an example embodiment, a provider computing entity 40 may be a computing entity operated by and/or on behalf of a contextual content provider and/or facilitator. In various embodiments, the provider computing entity 40 may be configured to mine one or more distributed ledgers to generate, update, and/or the like a user information/data data store (e.g., a user information/data database). For example, the provider computing entity 40 may access user information/data from one or more distributed ledgers and generate a user information/data data store based thereon. The provider computing entity 40 may then use the user information/data data store to provide user information/data for use in identifying, selecting, generating, and/or the like contextual content corresponding to the user. The provider computing entity 40 may then provide and/or facilitate provision of the contextual content to the user via the user computing entity 30.

In various embodiments, a provider computing entity 40 may interact with one or more node computing entities 200, 200′, the distributed ledger, and/or the distributed ledger system 100 to access, gather, mine, and/or the like user information/data corresponding to one or more users. In an example embodiment, a provider computing entity 40 may be in communication with one or more node computing entities 200, 200′ and/or one or more user computing entities 30 via one or more wired or wireless networks 135. In one embodiment, the provider computing entity 40 may include one or more components that are functionally similar to those of a node computing entity 200, 200′. For instance, in one embodiment, a provider computing entity 40 may include: (1) a processing element that communicates with other elements via a system interface or bus; (2) one or more user interface devices (e.g., display, touchscreen display, hard or soft keyboard, mouse, and/or the like); (3) transitory and non-transitory memory; and (4) a network and/or communications interface configured to communicate via one or more wired or wireless networks 135.

e. Exemplary Publisher Computing Entity

In an example embodiment, a publisher computing entity 50 may be a computing entity operated by and/or on behalf of an individual, group, entity, and/or the like publishing media. For example, the media may be published via a website, Internet-accessible portal, application, and/or the like (collectively referred to herein as a website unless otherwise noted). In various embodiments, the publisher computing entity 50 may be configured to store media and provide media via the website. For example, the publisher computing entity 50 may provide media, a website responsive to receiving a request for such generated and provided by a user computing entity 30.

In various embodiments, a publisher computing entity 50 may interact with one or more user computing entities 30, provider computing entities 40, exchange computing entities 60, and/or content computing entities 70, for example, via one or more wired or wireless networks 135. In one embodiment, the publisher computing entity 50 may include one or more components that are functionally similar to those of a node computing entity 200, 200′. For instance, in one embodiment, a publisher computing entity 50 may include: (1) a processing element that communicates with other elements via a system interface or bus; (2) one or more user interface devices (e.g., display, touchscreen display, hard or soft keyboard, mouse, and/or the like); (3) transitory and non-transitory memory; and (4) a network and/or communications interface configured to communicate via one or more wired or wireless networks 135.

f. Exemplary Exchange Computing Entity

In an example embodiment, an exchange computing entity 60 may be a computing entity operated by and/or on behalf of an individual, group, entity, and/or the like for determining content to be provided to one or more users. For example, the exchange computing entity 60 may operate an exchange in which one or more entities may bid for the ability to provide content to one or more users.

In various embodiments, an exchange computing entity 60 may interact with provider computing entities 40, publisher computing entities 50, and/or content computing entities 70, for example, via one or more wired or wireless networks 135. In one embodiment, the exchange computing entity 60 may include one or more components that are functionally similar to those of a node computing entity 200, 200′. For instance, in one embodiment, a publisher computing entity 50 may include: (1) a processing element that communicates with other elements via a system interface or bus; (2) one or more user interface devices (e.g., display, touchscreen display, hard or soft keyboard, mouse, and/or the like); (3) transitory and non-transitory memory; and (4) a network and/or communications interface configured to communicate via one or more wired or wireless networks 135.

g. Exemplary Content Computing Entity

In an example embodiment, a content computing entity 70 may be a computing entity operated by and/or on behalf of an individual, group, entity, and/or the like for storing content and providing content in response to a request. For example, the content computing entity 70 may store a content data store (e.g., content database). Based on information/data received from the exchange computing entity 60 (e.g., identifying an entity owning content stored in the content data store and/or a particular instance of content stored in the content data store), the content computing entity 70 may select one or more instances of content from the content data store and provide the one or more instances of content such that at least one of the one or more instances of content are received by the user computing entity 30 for display via a user interface thereof as part of a website.

In various embodiments, a content computing entity 70 may interact with provider computing entities 40, publisher computing entities 50, and/or exchange computing entities 60, for example, via one or more wired or wireless networks 135. In one embodiment, the content computing entity 70 may include one or more components that are functionally similar to those of a node computing entity 200, 200′. For instance, in one embodiment, a publisher computing entity 50 may include: (1) a processing element that communicates with other elements via a system interface or bus; (2) one or more user interface devices (e.g., display, touchscreen display, hard or soft keyboard, mouse, and/or the like); (3) transitory and non-transitory memory; and (4) a network and/or communications interface configured to communicate via one or more wired or wireless networks 135. In an example embodiment, the functions described as being performed by the exchange computing entity 60 and the content computing entity 70 may be performed by a single computing entity and/or group of computing entities (e.g., servers).

h. Exemplary Networks

In one embodiment, any two or more of the illustrative components of the architecture of FIGS. 1A and/or 1B may be configured to communicate with one another via respective communicative couplings to one or more networks 135. The networks 135 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 135 may have any suitable communication range associated therewith and may include, for instance, global networks (e.g., the Internet), MANs, WANs, LANs, or PANs. In addition, the networks 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### III. Exemplary System Operation

Example embodiments use a distributed ledger (e.g., blockchain or other distributed ledger) to generate, determine, and/or identify contextual content corresponding to a user. For example, transactions and/or events corresponding to the user and stored in a distributed ledger may be analyzed, reviewed, and/or the like to automatically generate, determine, and/or identify contextual content corresponding to the user. The contextual content determined, generated, and/or identified from the distributed ledger may provide a richer perspective of the user and/or the user's interests than traditional contextual content determining methods. In an example embodiment, the contextual content determined, generated, and/or identified from the distributed ledger is used to identify, generate, and/or determine contextual content to be served to the user. Example embodiments provide a new and unexplored source of contextual content corresponding to a user that is rooted in distributed ledger and computer network technology.

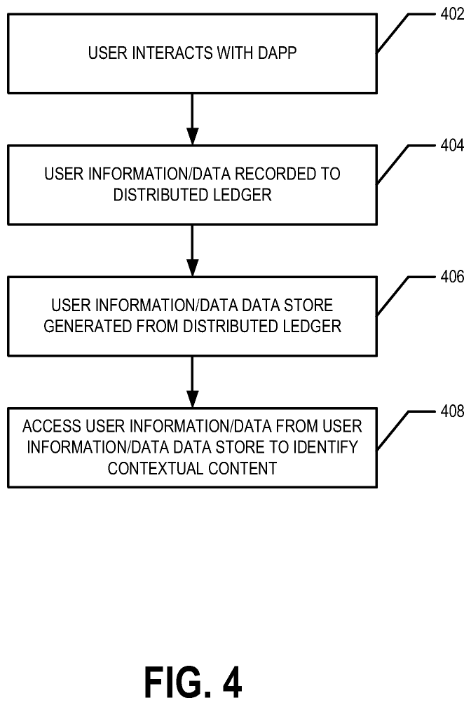

FIG. 4 provides a flowchart illustrating an overview of various example embodiments. Starting at step/operation 402, a user operating a user computing interacts with a dApp (e.g., via a user computing entity 30). For example, the dApp may be IDEX (decentralized cryptocurrency exchange), Crypt® Kitties (collectible, tradeable, unique digital assets), and PeepEth (decentralized version of Twitter), or various other dApps.

A dApp (or decentralized application) is a software service designed to store state and activity information/data on a decentralized network such as Ethereum, for example. Although dApp architecture can vary and is still subject to evolution it typically consists of a smart contract, web-based front-end, and sometimes separate data storage such as InterPlanetary File System (IPFS), Filecoin, Amazon Web Services (AWS) S3 Buckets, and/or the like. Users interact with the application via the web based front-end (e.g. standard html web site). The core “code” of the dApp is typically the smart contract. By interacting with the front-end, users can execute methods and functions in the smart contract. This will then trigger the smart contract to update the state of the dApp on the underlying distributed ledger (e.g., blockchain). Due to the relatively high cost of storage on distributed ledgers, dApps will often use cheaper distributed data storage from services like IPFS, Filecoin, or cloud storage (AWS S3). When this happens, typically data validation can be maintained by storing a pointer to the data and a hash of it on the underlying distributed ledger.

In order to interact with the underlying dApp smart contract, a user must have an account (e.g., of the dApp and/or underlying distributed ledger) and be able to spend tokens (e.g., Ether in the case of an Ethereum distributed ledger) to pay for the computation used by the smart contract. At the same time, the user cannot simply give the dApp control over the tokens (e.g., Ether) in their account. Typically, this tension is resolved by allowing a browser plugin such as MetaMask (or a wallet like Parity or Geth) to interact with the dApp such that a user must digitally sign (effectively a method of giving consent) any transactions that spend tokens. As a result of this interaction, transactions and/or events written to the distributed ledger are signed using the user's ledger address private and public key pairs. For example, a ledger address may be associated with one or more private and public key pairs. Any transactions and/or events written to the distributed ledger corresponding to activity and/or state modifications corresponding to the ledger address may be signed using the private key of a private and public key pair associated with the ledger address (e.g., by the dApp, plugin, and/or the like).

The user interaction with the dApp may cause, initiate, and/or the like one or more transactions and/or events. In various embodiments, at step/operation 404, one or more transactions and/or events corresponding to the user are recorded in entries of a distributed ledger (e.g., via one or more node computing entities 200, 200′) corresponding to the dApp. For example, if the dApp being interacted with by the user is PeepEth, the transaction and/or event may be the posting of a peep by the user. If the dApp being interacted with by the user is Crypt® Kitties, the transaction and/or event may be a transaction or trade of digital assets. In another example, if the dApp being interacted with by the user is IDEX, the transaction and/or event may be a cryptocurrency exchange. Thus, transactions and/or events corresponding to the user may be recorded to the distributed ledger.

At step/operation 406, a provider computing entity 40 may access user information/data (e.g., from recorded transactions and/or events corresponding to the user) from the distributed ledger and generate, maintain, and/or update a user information/data data store (e.g., user information database). In an example embodiment, the provider computing entity 40 may access multiple distributed ledgers to compile user information/data corresponding to a user that may use multiple platforms (e.g., a user may interact with both PeepEth and IDEX, for example). For example, records and/or entries of a distributed ledger may be read, and the transaction and/or event information/data be extracted therefrom. Users corresponding to the transaction and/or event information/data may be identified (e.g., based on ledger addresses corresponding to users) and the user information/data corresponding to a user may be compiled in a user information/data data store by the provider computing entity 40.

At step/operation 408, when a trigger is identified by the provider computing entity 40, for example, user information/data corresponding to the user may be accessed (e.g., via querying the distributed ledger and/or the user information/data data store) by the provider computing entity 40. In various embodiments, a trigger is identified in response to a user accessing, via the user computing entity 30, a website including contextual content serving code (e.g., including address code). The provider computing entity 40, in response to identifying the trigger, may use the user information/data to generate, identify, select, and/or the like contextual content to be provided to the user, by the provider computing entity 40 and/or another content serving computing entity. The contextual content may then be provided to the user (e.g., via the user computing entity 30) via the website. In an example embodiment, the website is a user interface of and/or associated with a dApp (e.g., associated with the dApp associated with the distributed ledger mined to generate the user information/data data store), a social media website, and/or another website (e.g., not connected to the dApp).

Generating, Updating, and/or Maintaining a User Information/Data Data Store

In various embodiments, a provider computing entity 40 may generate, update, and/or maintain a user information/data data store. For example, the provider computing entity 40 may access a distributed ledger and, starting with the root entry/record/block, read through each entry/record/block sequentially. As the provider computing entity 40 reads each entry/record/block, user information/data may be extracted from the transactions and/or events recorded in the entry/record/block. Once each entry/record/block of the distributed ledger has been read, the provider computing entity 40 may read each new entry/record/block as it's recorded and/or posted to the distributed ledger (e.g., in real-time or near real-time, in an example embodiment).

For example, the web3.js javascript library (and other similar libraries) can be used to identify a distributed ledger account of a user on a web page and/or application (sometimes this requires user permission). Once the distributed ledger account of a user is known, a search of the public distributed ledger for additional activity (e.g., transactions and/or events) by that distributed ledger account can reveal contextual targeting information/data. This information/data is permanently and irrevocably stored in the distributed ledger, although it may be difficult to translate or extract it.

As an example of available user information/data that can be collected, for users who use a distributed exchange like IDEX, the quantities and varieties of currencies that are traded can be determined. For users who use PeepEth, all the peeps posted by a user can be extracted. For users who trade CryptoKitties, the value of a user's collectables and the frequency of activity can be determined. Each of these types of user information/data can be used to generate targeted contextual content.

In order to more review the user information/data available from these dApps, a user information/data data store (e.g., user information database) is used to store dApp data (e.g., information/data corresponding to transactions and/or events) and meta-data from external sources for efficient access. This user information/data data store allows rapid access to all relevant information about a particular user (e.g., based on the corresponding ledger address). Such information can be used for generating contextual content.

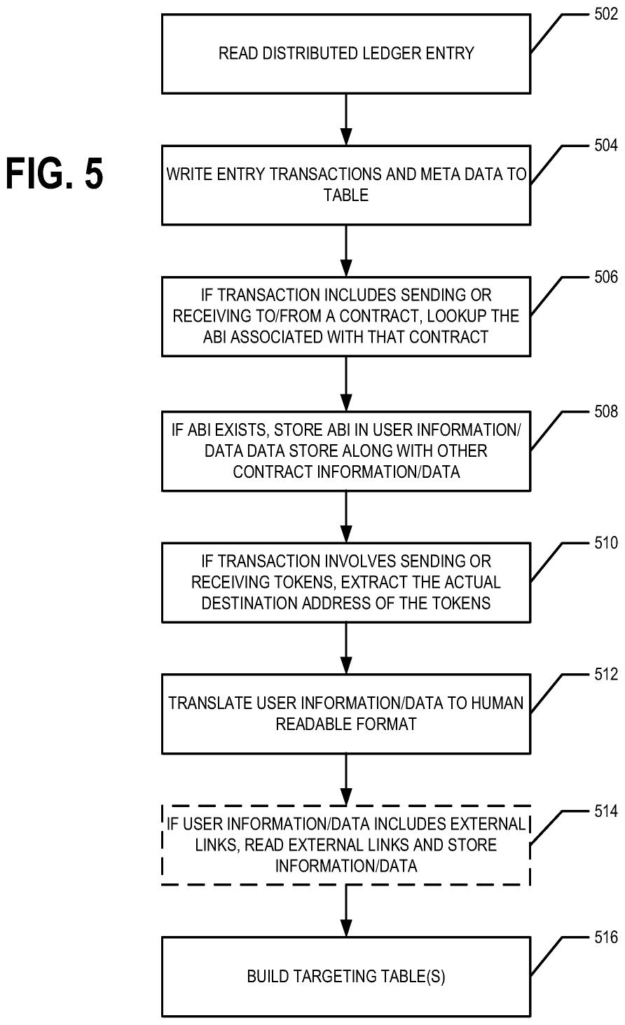

FIG. 5 provides a flowchart illustrating procedures, processes, operations, and/or the like performed by a provider computing entity 40 to generate, maintain, and/or update a user information/data data store, in various embodiments. Starting at step/operation 502, an entry/record/block of the distributed ledger is read. For example, the provider computing entity 40 may request and receive an entry/record/block of the distributed ledger and read the entry/record/block. The transaction/event information/data from the entry/record/block is mined and written to the user information/data data store in association with the corresponding users' ledger addresses. For example, at step/operation 504, each transaction and/or event of the entry/record/block is read, along with any meta-data related to that transaction and/or event. The transaction/event information/data and related meta-data are written to a table of user information/data data store.

At step/operation 506, if the transaction and/or event includes sending or receiving to/from a smart contract, the application binary interface (ABI) associated with that smart contract is accessed. For example, the provider computing entity 40 may determine whether the transaction and/or event includes sending or receiving to/from a smart contract and, responsive to determining that the transaction and/or event does include sending or receiving to/from a smart contract, the provider computing entity 40 may access the ABI associated with that smart contract. An ABI determines such details as how functions are called by the smart contract and in which binary format information should be passed from one program component to the next in the smart contract. At step/operation 508, if an ABI exists for the smart contract, the ABI is stored in the user information/data data store along with other information/data (e.g., meta-data) corresponding to the contract. For example, if, at step/operation 506, the provider computing entity 40 is able to access an ABI associated with the smart contract identified as being associated with the transaction and/or event, the provider computing entity 40 writes the ABI and any other available information/data corresponding to the smart contract to the user information/data data store. For example, if the smart contract is an ERC20 token, some example information/data corresponding to the smart contract that may be written to the user information/data data store includes the name of the token, the token symbol, the number of decimal places that the token recognizes, and/or the like.

At step/operation 510, if the transaction and/or event involves the sending or receiving of tokens, the actual destination address of the tokens are extracted. For example, the provider computing entity 40 may determine whether the transaction and/or event involves sending and/or receiving tokens, and, responsive to determining that the transaction and/or event does involve sending and/or receiving tokens, the provider computing entity 40 may extract the actual destination address of the tokens. In various embodiments, the actual destination address of the tokens is extracted by running a script to determine the actual destination address of the tokens. For example, the entry/record/block may comprise one or more transactions indicating that User A sent token X to Smart Contract Y and that Smart Contract Y sent token X to User B. The final destination of the token (e.g., User B's wallet, account, and/or the like in this example) is the destination of interest.

At step/operation 512, the information/data extracted from the transaction and/or event is translated into a human readable format. For example, the provider computing entity 40 may translate the information/data extracted from the transaction and/or event read from the entry/record/block of the distributed ledger into a human readable format. For example, a transaction and/or event that includes input data or log events, the data stored in the distributed ledger is frequently stored in a non-human readable form, such as Byte Code, hashed, and/or the like. For example, the information/data extracted from the transaction and/or event may be translated to standard text. In various embodiments, the translation of the information/data extracted from the transaction and/or event is performed the ABI associated with the transaction and/or event.

At step/operation 514, if the information/data extracted from the transaction and/or event includes external links, the external links may be read, and the corresponding information/data may be stored in the user information/data data store. For example, the provider computing entity 40 may determine whether the information/data extracted from the transaction and/or event includes external links and, responsive to determining that the information/data extracted from the transaction and/or event does include external links, the provider computing entity may read the external links, capture any information/data provided thereby, and write the captured information/data to the user information/data data store.

In various embodiments, steps/operations 502-514 are performed for each transaction and/or event of each entry/record/block of a distributed ledger (e.g., starting at the root entry/record/block and moving forward sequentially). Once each entry/record/block of the distributed ledger has been processed (e.g., via steps 502-514), any new entry/record/block posted to the distributed ledger may be processed (e.g., via steps 502-514) when the new entry/record/block is posted (e.g., in real-time or near real-time, in an example embodiment).

At step/operation 516, the information/data stored in the user information/data data store may be processed, filtered, and/or the like to generate one or more tables. For example, the provider computing entity 40 may process, filter, and/or the like the information/data stored in the user information/data data store to generate one or more tables. For example, the one or more tables may be configured to provide access to user information/data quickly and efficiently in response to a query comprising a ledger address. For example, the provider computing entity 40 may run scripts to build tables that allow for better targeting of contextual content for users. For example, a table may be built to show the total value of collectable digital assets such as Crypt® Kitties associated with one or more ledger addresses. In an example embodiment, the scripts are configured to compile the information/data (and/or meta-data) corresponding to transactions and/or events associated with a ledger address such that all of and/or the relevant user information/data associated with the ledger address is aggregated into a common location (e.g., a table entry). In various embodiments, the information/data stored in the user information/data data store is processed, filtered, and/or the like periodically to generate and/or maintain one or more tables. The tables may then be used to quickly and efficiently provide user information/data that may be used for determining, generating, identifying, selecting, and/or the like contextual information/data for a user (e.g., based on the corresponding ledger address).

### Providing Contextual Content to a User

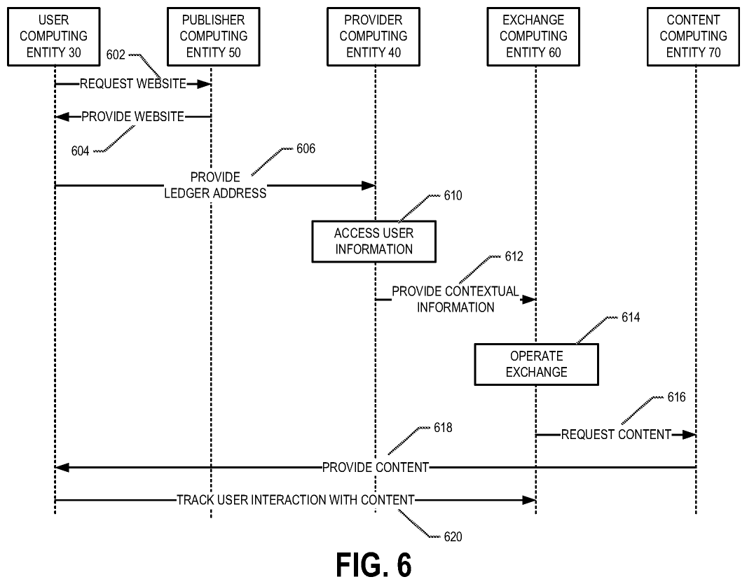

FIG. 6 provides a data flow diagram illustrating various processes, procedures, operations, and/or the like for providing content to a user, in accordance with an example embodiment. Starting at 602, a user operates a user computing entity 30 to access a media item via a website. For example, the user may interact with the user computing entity 30 via a user interface thereof and cause the user computing entity 30 to execute computer executable instructions for requesting a website comprising the media item. For example, the computer executable instructions may cause the user computing entity 30 to provide a web browser, dedicated application, and/or the like via which the user may access and/or interact with the media item, website.

The publisher computing entity 50 receives the request for the media item to be provided via the website and, at 604, provide the website comprising the media item. In an example embodiment, the website comprises address code, wherein the address code comprises computer executable instructions for extracting, identifying, determining, and/or the like a ledger address corresponding to the user operating the user computing entity 30. For example, the address code may be embedded in the website. In various embodiments, the address code uses web3.js or a similar library to determine the ledger address. For example, the address code may communicate with a plugin operating in and/or alongside the web browser, dedicated application, and/or the like (e.g., meta-mask, a wallet related plugin, and/or the like) operating on the user computing entity to obtain the ledger address (e.g., from the plugin). In various embodiments, the user computing entity 30 executes the address code, thereby causing the ledger address corresponding to the user operating the user computing entity 30 to be identified. The user computing entity 30 may then provide the ledger address such that the provider computing entity 40 receives the ledger address, at 606, for example through execution of the address code.

At 610, the user information/data corresponding to the ledger address is accessed from the user information/data data store. For example, the user information/data data store may be queried using the ledger address to identify user information/data corresponding to the user operating the user computing entity 30. In an example embodiment, the provider computing entity 40 may determine contextual information/data from the user information/data. For example, based on the user information/data accessed from the user information/data data store may be analyzed to determine contextual information/data therefrom. For example, the provider computing entity 40 may execute computer-executable code configured to use one or more rules to determine contextual information/data from the user information/data corresponding to the ledger address. In an example embodiment, the contextual information/data comprises a portion of the user information/data that is expected to be most useful and/or productive in determining and/or identifying content to provide to the user. In an example embodiment, the contextual information/data comprises one or more keywords extracted from or determined and/or generated based on the user information/data. In an example embodiment, the one or more rules used may depend on an exchange that will be used to determine one or more characteristics of the content to be provided to the user. For example, multiple exchanges (e.g., possibly operated by multiple exchange computing entities 60) may be available for use. An exchange may be configured to determine one or more characteristics of content to be provided by a user. In an example embodiment, one or more entities may bid for the right to provide and/or select content to be provided to the user and/or to determine and/or define one or more characteristics of the content to be provided to the user. Based on the exchange intended for use in determining the one or more characteristics, the one or more rules may be configured to determine contextual information/data from the accessed user information/data, in an example embodiment.

At 612, the provider computing entity 40 provides the contextual information/data such that the exchange computing entity 60 receives the contextual information/data. The exchange computing entity 60 then conducts the exchange based on the contextual information/data, at 614. The result of the exchange is the determination and/or defining of one or more characteristics of the content to be provided to the user. In an example embodiment, the one or more characteristics of the content may include an entity associated with the content (e.g., a sponsor of the content, a creator of the content, a supporter of the content, a brand associated with the content, and/or the like), a particular instance of content (e.g., a content identifier that uniquely identifies an instance of content), content subject matter (e.g., a sports team, a sports league or event, celebrity, a product, and/or the like), a visual aspect of the content (e.g., a color, aesthetic style, and/or the like), a keyword, and/or other characteristics corresponding to the subject matter, visual aspects, and/or meta-data associated with the content. In various embodiments, the exchange may include a Real-time Bidding (RTB) exchange, a static auction (e.g., similar to Google Adwords), and/or the like. In an example embodiment, the winner of the bidding and/or auction defines and/or determines the one or more characteristics.

At 616, the exchange computing entity 60 provides a request for the content such that the content computing entity 70 receives the request. In an example embodiment, the request for the content comprises the determined one or more characteristics. Based on the one or more determined characteristics, the content computing entity 70 identifies one or more instances of content from the content data store. For example, the content computing entity 70 may query the content data store, meta-data associated with content stored in the content data store and/or the like, based on the one or more characteristics to identify one or more instances of content.

At 618, the content computing entity 70 provides one or more instances of content accessed from the content data store. The user computing entity 30 and/or publisher computing entity 50 may receive the instance(s) of content and incorporate at least one instance of content into the website providing the media item. For example, the content may be provided via a user interface of the user computing entity 30 as part of the website providing the media item. In various embodiments, the process of providing the content happens in real-time or near real-tie with respect to the request for the media item, website being provided by the user computing entity 30. For example, in an example embodiment, the time between 602 and 618 is less than two seconds (e.g., approximately one second). Thus, the user experience of the website providing the media item is such that the instance(s) of content appear to be provided as part of the website alongside the media item without any noticeable or significant delay in the provision of the media item. In various embodiments, an instance of content may be sports scores for a particular sports league, a game schedule for a particular sports team, election results for a particular election, an advertisement, a public service announcement, and/or other content that, based on the contextual information/data appears to be relevant or possibly of interest to the user operating the user computing entity 30 and/or corresponding to the ledger address.

At 620, the exchange computing entity 60 tracks user interaction with the instance(s) of content. For example, if a user (e.g., operating the user computing entity 30) clicked on the content and/or accessed another website and/or the like via the content, the exchange computing entity 60 may track such user interaction. In various embodiments, the tracked user interaction may be used to refine the rules used to determine contextual information/data for an exchange operated by the exchange computing entity 60, refine the exchange, and/or the like.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
at least one processor;
at least one memory storing computer program code and a user information data store; and
a communication interface configured for communicating via at least one network,
the at least one memory and the computer program code are configured to, with the processor, cause the apparatus to at least:
receive a ledger address, the ledger address corresponding to a user of a distributed ledger-based distributed application,
access user information corresponding to the ledger address from the user information data store,
analyze the user information to determine contextual information, and
provide the contextual information such that an exchange computing entity receives the contextual information,
wherein:
the exchange computing entity uses the contextual information to determine one or more characteristics of an instance of content; and
a content computing entity accesses an instance of content from a content data store and provides the instance of content such that a user computing entity receives the content and provides the content as part of a website.

2. The apparatus of claim 1, wherein the ledger address identifies a token storing location corresponding to (a) a user of the user computing entity and (b) the distributed ledger.

3. The apparatus of claim 1, wherein the ledger address corresponds to a user operating the user computing entity.

4. The apparatus of claim 1, wherein the user information data store is generated by mining user information from the distributed ledger.

5. The apparatus of claim 4, wherein at least some of the user information is mined from entries added to the distributed ledger in at least near real time with respect to the entries being added to the distributed ledger.

6. The apparatus of claim 1, wherein the user information is analyzed based on one or more rules to generate the contextual information.

7. The apparatus of claim 6, wherein an exchange operated by the exchange computing entity is used to determine the one or more characteristics of the instance of content and the one or more rules correspond to the exchange.

8. The apparatus of claim 6, wherein the contextual information comprises a keyword.

9. The apparatus of claim 1, wherein the ledger address is determined and provided such that the apparatus receives the ledger address in response to the user computing entity accessing a website.

10. The apparatus of claim 9, wherein the website has embedded therein computer executable instructions for determining the ledger address and causing the ledger address to be provided such that the apparatus receives the ledger address.

11. A method for providing contextual content to a user operating a user computing entity, the method comprises:
receiving, by a provider computing entity, a ledger address, the ledger address corresponding to a user of a distributed ledger-based distributed application;
accessing, by the provider computing entity, user information corresponding to the ledger address from a user information data store stored in a computer-readable memory of the provider computing entity;
analyzing, by the provider computing entity, the user information to determine contextual information; and
providing, by the provider computing entity, the contextual information such that an exchange computing entity receives the contextual information,
wherein:
the exchange computing entity uses the contextual information to determine one or more characteristics of an instance of content; and
a content computing entity accesses an instance of content from a content data store and provides the instance of content such that a user computing entity receives the content and provides the content as part of a website.

12. The method of claim 11, wherein the ledger address corresponds to a user operating the user computing entity.

13. The method of claim 11, wherein the user information data store is generated by mining user information from the distributed ledger.

14. The method of claim 13, wherein at least some of the user information is mined from entries added to the distributed ledger in at least near real time with respect to the entries being added to the distributed ledger.

15. The method of claim 11, wherein the user information is analyzed based on one or more rules to generate the contextual information.

16. The method of claim 15, wherein an exchange operated by the exchange computing entity is used to determine the one or more characteristics of the instance of content and the one or more rules correspond to the exchange.

17. The method of claim 15, wherein the contextual information comprises a keyword.

18. The method of claim 11, wherein the ledger address is determined and provided such that the apparatus receives the ledger address in response to the user computing entity accessing a website.

19. The method of claim 18, wherein the website has embedded therein computer executable instructions for determining the ledger address and causing the ledger address to be provided such that the apparatus receives the ledger address.

20. A computer program product comprising at least one non-transitory computer-readable storage medium having computer-executable program code instructions stored therein, the computer-executable program code instructions comprise program code instructions configured to:
receive a ledger address, the ledger address corresponding to a user of a distributed ledger-based distributed application;
access user information corresponding to the ledger address from a user information data store;
analyze the user information to determine contextual information; and
provide the contextual information such that an exchange computing entity receives the contextual information;
wherein:
the exchange computing entity uses the contextual information to determine one or more characteristics of an instance of content; and
a content computing entity accesses an instance of content from a content data store and provides the instance of content such that a user computing entity receives the content and provides the content as part of a web site.
